(19) United States
(12) Patent Application Publication
(10) Pub. No.: US 2011/0116642 A1
(43) Pub. Date: May 19, 2011

(54) Audio System with Portable Audio Enhancement Device

(75) Inventors: James Hall, Topanga, CA (US); Andy Wehmeyer, Pasadena, CA (US); Ulrich Horbach, Canyon Country, CA (US)

(73) Assignee: Harman International Industries, Incorporated, Northridge, CA (US)

(21) Appl. No.: 12/619,676

(22) Filed: Nov. 16, 2009

(51) Int. Cl. H04R 29/00; H04H 40/00

(52) U.S. Cl. 381/58; 455/3.06; 381/122

(57) ABSTRACT

A portable audio enhancement device is configured for enhancing audio signals, and may be utilized in an audio system. The audio system may include a portable audio source, the audio enhancement device, an audio playback device, and a loudspeaker. The audio enhancement device receives audio signals from the audio source and produces enhanced audio signals. The audio playback device receives the enhanced audio signals and outputs the enhanced audio signals to the loudspeaker for playback. Enhancement of the audio signals may be based on an analysis performed by the audio enhancement device by measuring sample audio signals derived from the sound outputted from the loudspeaker.

### BACKGROUND OF THE INVENTION

1. Field of the Invention

This invention relates to a portable audio enhancement device and related audio system, in which the audio enhancement device is able to be quickly and easily connected between a variety of different types of audio sources and audio playback devices.

2. Related Art

A portable audio source, or digital music player, provides the conveniences of portability and large capacity for storing digital audio files such as music tracks, voice recordings, and the like. Depending on the capacity of the memory provided, which may be internal memory, a removable memory unit or a combination of both, a portable audio source may be capable of providing immediate access to thousands of digital audio files and thus many hours of listening time. This large storage capacity is readily contrasted with a conventional audio playback system such as a home stereo or vehicle stereo, which is typically limited to storing and driving a single CD or sometimes six CDs. The portable audio source typically enables a user to organize the audio files according to artist, record album, genre or the like, or customized playlists, as well as search for and select desired audio files and play the selected audio files through headphones, through connection to a personal computer, via docking with a loudspeaker system, etc. Recent models of audio playback systems are configured to connect to these types of portable audio sources and process the audio formats provided by them. Thus, for example, a portable MP3 player may be connected to an auxiliary input jack of an in-dash vehicle stereo, allowing the user to select audio files stored on the MP3 for playback through the loudspeakers of the vehicle.

A widely perceived drawback to the use of digital audio files is that they are typically data-compressed when stored on the portable audio source so as to conserve memory space, such that the digital audio file is missing information as compared to the same audio file when stored on a CD. However, the quality of the playback sourced from a digital audio file also depends greatly on the quality of the hardware being utilized to achieve playback and the acoustics of the listening environment. For instance, sound played through headphones or the loudspeakers of low-priced plastic-housing docking stations will typically be inferior to sound played through an array of high-quality loudspeakers provided by a home stereo or vehicle stereo system. Moreover, sound played in the interior of a vehicle will often be inferior to sound played in the room of a building, due to the complex array of sound-reflecting and sound-absorbing surfaces existing in the vehicle's interior and because loudspeakers cannot be optimally positioned within the vehicle's interior due to design constraints. Many audio systems provide user-adjustable equalizers and other sound-enhancing products in conjunction with portable audio sources and audio playback devices, but these products merely make internal adjustments to the audio signals being processed. That is, these products do not correct the acoustic system, i.e. they are not capable of taking into account the deficiencies in the actual sound actually being propagated into the listening environment. Moreover, many of these sound-enhancing products are embodied in software programs requiring the use of a personal computer. Automatic equalizers have, however, been developed for making frequency and phase adjustments, but these products must be permanently installed as an aftermarket feature between the main electronics and amplifiers of the associated audio playback device and thus reside within the internal signal path of the audio playback device.

Therefore, there is a need for providing an audio enhancement device that is portable and compatible with a wide variety of portable audio sources (e.g., digital music players) and audio playback devices (e.g., home or car stereo systems). There is also a need for providing an audio enhancement device that improves sound quality by correcting frequency response or both frequency and phase response. There is also a need for providing an audio enhancement device capable of adjusting itself to the performance of the audio system to which it is connected. There is also a need for providing an audio enhancement device capable of making adjustments or corrections to sound playback according to the position of the listener relative to the loudspeakers of the system.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one implementation, a portable audio enhancement device includes an audio input configured for receiving audio signals from a portable audio source located separately from the portable audio enhancement device, an audio signal processor configured for processing the audio signals to produce enhanced audio signals, and an audio output configured for outputting the enhanced audio signals to an audio playback device located separately from the portable audio enhancement device.

According to another implementation, the portable audio enhancement device includes a microphone for converting sound into sample audio signals, and the audio signal processor is configured for performing an analysis of the sample audio signals and performing an enhancement based on the analysis.

According to another implementation, the portable audio enhancement device is configured for generating a correction filter based on the analysis and applying the correction filter to the audio signals received by the audio input to produce the enhanced audio signals.

According to another implementation, an audio system includes a portable audio source, a portable audio enhancement device, an audio playback device, and one or more loudspeakers. The portable audio source includes circuitry configured for producing audio signals for output, and a first audio output configured for outputting the audio signals. The portable audio enhancement device is located separately from the portable audio source. The portable audio enhancement device includes a first audio input configured for receiving the audio signals from the first audio output via a first communication link, an audio signal processor configured for processing the audio signals to produce enhanced audio signals, and a second audio output configured for outputting the enhanced audio signals. The audio playback device is located separately from the portable audio source and the portable audio enhancement device. The audio playback device includes a second audio input configured for receiving the enhanced audio signals from the second audio output via a second communication link, and circuitry configured for producing the enhanced audio signals for playback. The one or more loudspeakers communicate with the audio playback device for converting the enhanced audio signals into sound and outputting the sound.

According to another implementation, a method is provided for enhancing sound outputted by an audio playback device. A portable audio enhancement device is placed in signal communication with an audio output of a portable audio source and with an audio input of an audio playback device. Audio signals are transmitted to the portable audio enhancement device. The portable audio enhancement device is operated to perform an enhancement on the audio signals to produce enhanced audio signals. The enhanced audio signals are transmitted to the audio playback device. The audio signals are outputted as sound from one or more loudspeakers communicating with the audio playback device.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a block diagram of an example of an implementation of an audio system utilizing a portable audio enhancement device.

FIG. 2 is a block diagram of another example of an implementation of an audio system utilizing a portable audio enhancement device.

FIG. 3 is a block diagram of another example of an implementation of an audio system utilizing a portable audio enhancement device.

FIG. 4 is a block diagram of another example of an implementation of an audio system utilizing a portable audio enhancement device.

FIG. 5 is a block diagram of another example of an implementation of an audio system utilizing a portable audio enhancement device.

FIG. 6 is a front view of an example of an implementation of a portable audio enhancement device that may be utilized in an audio system such as shown in FIGS. 1-5.

FIG. 7 is a block diagram of an example of an implementation of a portable audio enhancement device that may be utilized in an audio system such as shown in FIGS. 1-5.

FIG. 8 is a block diagram of an example of an implementation of a portable audio source that may be utilized in an audio system such as shown in FIGS. 1-5.

FIG. 9 is a block diagram of an example of an implementation of an audio playback device that may be utilized in an audio system such as shown in FIGS. 1-5.

### DETAILED DESCRIPTION

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

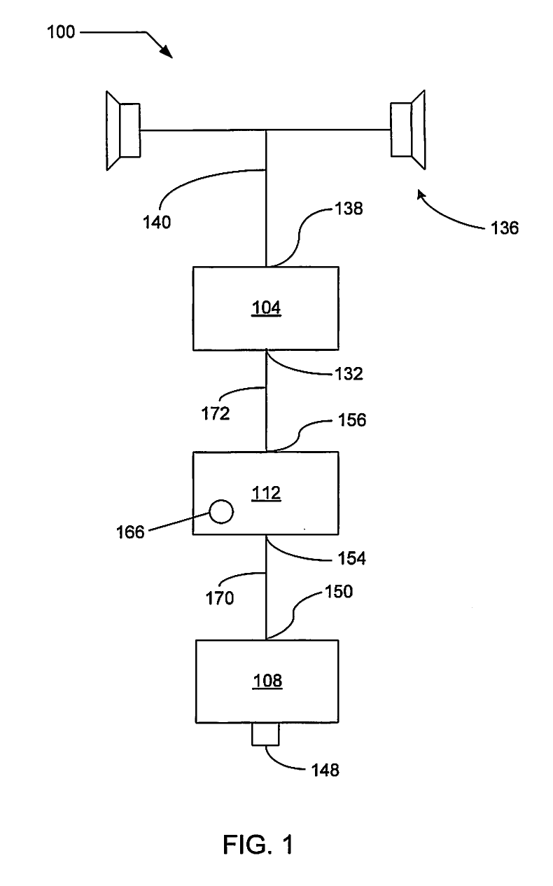

FIG. 1 is a block diagram of an example of an implementation of an audio system 100. The audio system 100 may generally include an audio playback device 104, a portable audio source 108, and a portable audio enhancement device 112. In the present context, the term “portable” means that the portable audio source 108 and the portable audio enhancement device 112 are physically separate devices in relation to the audio playback device 104, may be easily connected in signal communication or disconnected from the audio playback device 104 without undue installation efforts, and may be easily carried by the user from one location to another. Moreover, the portable audio source 108 and the portable audio enhancement device 112 are operable independently of the audio playback device 104. That is, the portable audio source 108 and the portable audio enhancement device 112 are generally not required to be in signal communication with any specific audio playback device 104 or type of audio playback device 104 for their respective operations. Additionally, the portable audio source 108 is typically a device that may be operated alone without being in signal communication with either the audio playback device 104 or the audio enhancement device 112. As another way of characterizing the portable nature of the portable audio source 108 and the portable audio enhancement device 112, these devices are physically separate devices, are located separately from each other and from the audio playback device 104, may be placed in signal communication with each other over any suitable distance by way of physical signal paths (such as, for example, electrical connections and/or conduits) or wireless signal paths (such as, for example, wireless links).

In this application, it is appreciated by those skilled in the art that the phrase “in signal communication” generally refers to any type of communication and/or connection between the devices (such as, for example, the audio playback device 104, portable audio source 108, and portable audio enhancement device 112) that allows a given device to pass and/or receive signals and/or information from another device. Specifically, “in signal communication” refers to any type of communication and/or connection between circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electrical conduits, electromagnetic wave guides, attached and/or electromagnetic or mechanically coupled terminals, semi-conductive or dielectric materials or devices, ionic, or fluidic, structural, or mechanical relationships or other similar physical connections or couplings. Additionally, signal paths may be non-physical such as free-space (in the case of electromagnetic propagation) or information paths through digital components where communication information is passed from one circuit, component, module, and/or device to another in varying digital formats without passing through a direct electromagnetic connection. For the purposes of this application, the term “coupled” may be interchangeably utilized with the phrase “in signal communication” and “communication link” may be interchangeably utilized with the phrase “signal path.” It is also appreciated that the fact that one component is said to communicate with a second component is not intended to exclude the possibility that additional components may be present between, and/or operatively associated or engaged with, the first and second components.

The audio playback device 104 may be any type of audio or multimedia device or system configured to provide audible playback of sound from an audio source and/or audible/visible playback of sound and video from an audio/video source. Non-limiting examples of the audio playback device 104 include a vehicle stereo system, a home stereo system, a personal computer with playback functionality, etc. In the present context, the term “stereo system” is utilized broadly to encompass various types of multimedia systems, entertainment systems, multi-channel audio systems, etc. Typically, the audio playback device 104 is a stand-alone system or device that includes its own hardware for driving an audio source, reading and processing audio signals from the audio source, and outputting sound derived from those audio signals. As examples, the audio playback device 104 may include one or more media drives for receiving and reading removable media, such as a CD player, a DVD player, a tape player, or the like. The audio playback device 104 may also include an audio file (e.g., .wav, MP3, etc.) processor, a radio or satellite tuner, etc. The audio playback device 104 may be a device normally operated in a stationary or fixed installation, or may be a portable device. In one example, the audio playback device 104 is a vehicle stereo system that is mounted in a fixed manner in an appropriate location in a vehicle (e.g., dashboard, head unit, console, etc.).

In the present example, the audio playback device 104 further includes an audio signal input 132 configured to be in signal communication with an auxiliary audio source, i.e., an audio source external to the audio playback device 104. As an example, the audio input 132 may be a female connector or line input jack of a standard size (e.g., 3.5 mm diameter) into which the audio output line from an auxiliary audio source may be plugged. For outputting playback material, the audio playback device 104 is in signal communication with one or more loudspeakers 136 via an audio signal output 138 and associated audio output lines 140. Typically, at least two loudspeakers 136 are provided for playback of stereo sound through left and right channels. An array of loudspeakers 136 may be provided for outputting sound within specific frequency ranges (e.g., tweeters, midrange speakers, woofers, subwoofers), for providing front and rear channels, for providing surround sound, etc. The loudspeakers 136 shown in FIG. 1 are representative of all such possible loudspeaker configurations.

The portable audio source 108 may be any device—typically handheld but at least easily transportable by a user—capable of outputting audio information of any type as noted above. The portable audio source 108 may, for example, be a handheld digital music player, CD player, or radio that is normally coupled to headphones for playback of audio information. The portable audio source 108 may be a multimedia or multi-functional device capable of playing one or more of these types of audio information. In the present context, “audio information” encompasses any type of data or information from which audio signals can be generated or processed and outputted from the portable audio source 108. Thus, as examples, audio information may be audio files such as may be stored in an internal or removable memory of the portable audio source 108, audio files such as may be stored on removable media driven by the portable audio source 108 (e.g., a CD, DVD, cassette tape, or the like), or wirelessly broadcasted content (e.g., via radio, satellite, or the like) that is received and processed by the portable audio source 108 over a channel selected by the user. In one example, the portable audio source 108 is capable of storing audio files in an internal or removable memory unit (not shown) and/or on removable media, and/or receiving and extracting audio information from wireless broadcasts. The portable audio source 108 may be further capable of allowing the user to select a stored audio file, or a station or channel over which to receive wireless broadcasts of audio information, to be outputted as a stream of audio signals for playback to the user via headphones, via docking to a loudspeaker (e.g., such as may be provided as an accessory for a specific brand of digital music player), or via auxiliary input connection to another playback device (e.g., home stereo or car stereo). Non-limiting examples of audio files include .wav files, MP3 files, CD files, DVD files, or any other suitable type of storable audio file. Non-limiting examples of the portable audio source 108 include various types of portable music players (e.g., Sansa® models commercially available from Sandisk, iPod® models commercially available from Apple, etc.), disk players (e.g., Sony Walkman® models), radio or satellite receivers, cellular telephones with audio file storage and processing capabilities, personal digital assistants (PDAs) with audio file storage and processing capabilities, etc.

The portable audio source 108 further includes an audio signal output 150, which may be a line output jack of standard size or some other type of electrical connector adapted to interface with a desired external device. For example, the audio output 150 may be configured to receive the plug of a set of headphones, allowing the user to hear the playback of a selected audio file. In this example, the portable audio source 108 is also configured to be placed in signal communication with an external playback device (i.e., the audio playback device 104 in the present example) to enable a user to transmit analog audio signals representing the selected digital audio file to the external playback device instead of to headphones. Depending on the type of portable audio source 108, the audio signals may be outputted to the external playback device via either the audio output 150 normally utilized for headphones or a data port 148.

In a conventional implementation, the portable audio source 108 would be coupled directly to the audio playback device 104 via a signal path that would include interconnecting an electrical conductor of a desired length (e.g., wire, cord, cable, or the like) to the audio output 150 of the portable audio source 108 and the audio input 132 of the audio playback device 104. In a vehicle application, for example, a portable music player may be in signal communication to the auxiliary input of the vehicle's stereo system, thereby allowing the user to play audio files stored on the portable music player through the vehicle's stereo system. By contrast, the portable audio enhancement device 112 is interconnected between the portable audio source 108 and the audio playback device 104 to significantly improve the quality of the audio content played back through the loudspeakers 136 of the audio playback device 104.

The portable audio enhancement device 112 generally includes audio signal processing circuitry (not shown), an audio signal input 154, and an audio signal output 156. The portable audio enhancement device 112 may also include a microphone 166 for further audio quality enhancement, as described in more detail below. The microphone 166 may be internal, or integrated with the portable audio enhancement device 112, or may be external and connectable to/disconnectable from the portable audio enhancement device 112. The portable audio enhancement device 112 is placed in signal communication with the portable audio source 108 by interconnecting the audio output 150 of the portable audio source 108 and the audio input 154 of the portable audio enhancement device 112 via a suitable communication link 170. The portable audio enhancement device 112 is placed in signal communication with the audio playback device 104 by interconnecting the audio output 156 of the portable audio enhancement device 112 and the audio input 132 of the audio playback device 104 via a suitable communication link 172. The audio inputs 132, 154 and the audio outputs 150, 156 may be line jacks of a standard size (e.g., 3.5 mm) in which case the communication links 170, 172 are physical lines (i.e., electrical conductors, conduits, wires, cables, etc.) with terminals or plugs adapted for interfacing with standard line inputs and line outputs. Alternatively, the audio inputs 132, 154 and the audio outputs 150, 156 may be part of wireless transmission circuitry in which case the communication links 170, 172 are wireless links.

The portable audio enhancement device 112 may be located anywhere in relation to the portable audio source 108 and the audio playback device 104. As examples, the portable audio enhancement device 112 may be carried by the user in a pocket of the user's clothing or in a carrying receptacle worn by the user, or may be placed or mounted at a nearby location, or may be placed in a tray of a vehicle's center console, mounted to a vehicle's visor, placed in a vehicle's glove compartment, etc.

The audio signal processing circuitry of the portable audio enhancement device 112 generally includes audio signal enhancement circuitry, which may be any type of circuitry configured for performing an enhancement (or adjustment, correction, etc.) on the audio signals received from the portable audio source 108 so as to produce enhanced audio signals for output to an external device such as the audio playback device 104. As examples, the enhancement may be a frequency response enhancement, a phase response enhancement, an impulse response enhancement, a dynamic range enhancement, combinations of two or more of the foregoing, as well as other types of enhancements that improve sound quality as appreciated by persons skilled in the art. In some implementations, the audio signal enhancement circuitry includes equalization circuitry (i.e., an equalizer, or EQ). The equalizer may be configured to perform equalization in time as well as in frequency. The audio signal processing circuitry may also include circuitry for implementing various other audio signal enhancing functions such as, for example, channel delay, dynamic range compression, reverb, etc. The audio signal processing circuitry may include dedicated circuitry configured to implement the various audio signal enhancing functions. Such circuitry may be analog and/or digital. In addition to implementation by way of hardware or firmware attributes, the circuitry may implement audio signal enhancing functions by executing software instructions or algorithms stored in a memory of the portable audio enhancement device. In one example, the circuitry includes a digital signal processor (DSP).

As an example of an implementation, the audio signal processing circuitry of the portable audio enhancement device 112 is configured for implementing automatic equalization. In this implementation, a user may initiate an automatic equalization set-up routine by manipulating a control that activates the microphone 166, and/or by connecting the microphone 166 to the portable audio enhancement device 112 in the case of an external microphone 166. The user then operates the portable audio source 108 and the audio playback device 104 to play an audio file stored on the portable audio source 108 (or a wireless broadcast or other type of audio information outputted by the portable audio source 108) via the loudspeakers 136 of the audio system 100. During playback, the microphone 166 (or the entire portable audio enhancement device 112 in the case of an integrated microphone 166) may be located near the user's ears such as by mounting the microphone 166 at or near the user's head by any suitable means. In a vehicle application, for instance, the driver, a front seat passenger, or a rear seat passenger may “wear” the microphone 166 or mount the microphone 166 to a location within the vehicle proximate to that particular user. During playback, and with the microphone 166 connected and positioned as desired, the user may initiate an audio enhancement set-up routine by manipulating a suitable user-input control provided on the portable audio enhancement device 112. The microphone 166 receives the sound being outputted from the audio system's loudspeakers 136 and converts the sound into sample (or test) audio signals. The DSP (or other type of audio enhancement circuitry) analyzes the audio system's impulse response (which may include both frequency and phase response) to determine whether deficiencies exist that should be corrected, by making measurements of the sample audio signals provided by the microphone 166. The DSP then calculates an appropriate calibration or correction filter, which may then be stored in the memory of the portable audio enhancement device 112. The portable audio enhancement device 112 may be configured to indicate to the user when the analysis has been completed, at which time the user may disconnect the microphone 166 from the portable audio enhancement device 112 (in the case of an external microphone 166). The user may then continue normal operation of the portable audio source 108 and the audio playback device 104, during which time the portable audio enhancement device 112 implements the correction filter whereby the sound outputted from the loudspeakers 136 is optimized.

As an example of operating the audio system 100, a user places the portable audio enhancement device 112 in signal communication with the portable audio source 108 and the audio playback device 104, and operates the portable audio enhancement device 112 to calibrate the audio system 100, in the manner described above. The user then operates the portable audio source 108 to select an audio file (or other type of audio information) for playback by the audio system 100. The portable audio source 108 processes the selected audio file so as to transmit audio signals representing the audio file to the portable audio enhancement device 112 via the communication link 170. The portable audio enhancement device 112 processes the received audio signals according to the correction filter it previously generated during set-up to produce enhanced audio signals, and transmits the enhanced audio signals to the audio playback device 104 via the communication link 172. The audio playback device 104 processes the received enhanced audio signals as necessary for playback and outputs the enhanced audio signals to the loudspeakers 136 for conversion to sound.

As long as it is interconnected between the portable audio source 108 and the audio playback device 104, the portable audio enhancement device 112 will continue to apply the same, previously created correction filter to enhance the audio signals being transmitted from the portable audio source 108 to the audio playback device 104. However, the enhancement function of the portable audio enhancement device 112 may be defeated by the user via a suitable user-input control, in which case the analog signals originally outputted by the portable audio source 108 pass through the portable audio enhancement device 112 to the audio playback device 104 without enhancement. Moreover, the portable audio enhancement device 112 may be subsequently operated to generate a new correction filter. For instance, in a vehicle application, a different user (e.g., a second driver of the vehicle, or a person occupying a different position in the vehicle, etc.) may desire to tailor the audio enhancement to his or her circumstances. As another example, a user may utilize the portable audio enhancement device 112 in connection with a home stereo to enhance sound output to a room, and subsequently utilize the portable audio enhancement device 112 in connection with a vehicle stereo to enhance sound output to the vehicle's interior. As another example, a user may utilize the portable audio enhancement device 112 in connection with one vehicle and then utilize the portable audio enhancement device 112 in connection with a different vehicle.

It thus may be seen that the portability of the audio enhancement device 112, and the ease with which it may be coupled to various types of portable audio sources 108 and audio playback devices 104, and in either mobile or other types of environments, provide many benefits to the user of the portable audio enhancement device 112. The portable audio enhancement device 112 is a plug-and-play solution that does not require any hardware or software related modifications to either the portable audio source 108 or the audio playback device 104. Moreover, by being intercoupled between the portable audio source 108 and the audio playback device 104, as opposed to within the audio signal processing path of the audio playback device 104, the portable audio enhancement device 112 is able to improve the quality of the listening experience by equalizing the audio signal based on an analysis of the deficiencies of not only the audio playback device 104 but also the entire audio system 100, i.e., based on measurements of the sounds actually being outputted through the loudspeakers 136 and propagated to the position of the user as a result of the performance of the audio system 100 as a whole. Depending on the severity of the original deficiencies of the audio system 100 and/or the listening environment (e.g., room of a building, vehicle interior, etc.), the result may be a dramatic improvement in frequency response and stereo imaging.

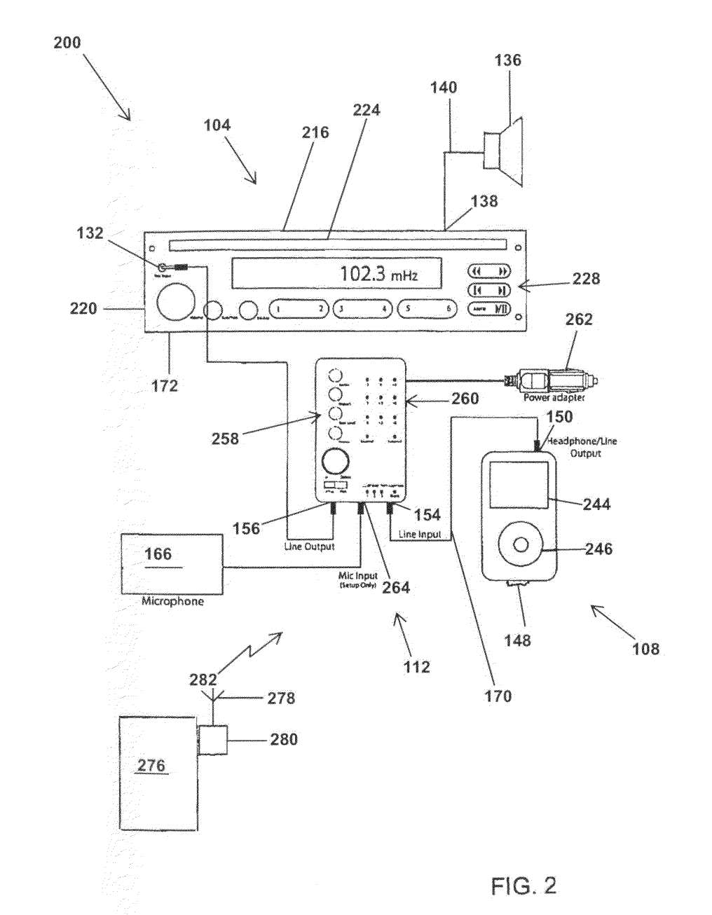

FIG. 2 is a block diagram of another example of an implementation of an audio system 200. Elements of the audio system 200 that are the same or similar to those of the audio system 100 described above and illustrated in FIG. 1 are designated by the same reference numerals and their description will not be repeated here. In the example of FIG. 2, the audio playback device 104 may include a main front panel or faceplate 220. The front panel 220 may provide one or more slots for loading various media into respective media drives 216, one or more displays 224 for presenting information to the user, and a plurality of user input elements 228 for enabling the user to control or adjust various parameters and functions of the audio playback device 104. In this example, the audio playback device 104 includes an audio signal input 232 that may be located directly on or near the front panel 220. The audio input 232 may, for example, be a female connector or line input jack of a standard size (e.g., 3.5 mm diameter) into which the audio output line (i.e. communication link 172) from an auxiliary audio source may be plugged. In the case of a vehicle application, the audio input 232 may alternatively be located elsewhere such as on a center console of the vehicle, or in a glove compartment of the vehicle, etc.

Also in the example of FIG. 2, the portable audio source 108 includes a display 244 (e.g., LCD) and a user input mechanism 246. The user input mechanism 246 may include one or more elements or controls such as an enter or select button for selecting commands and/or audio files (or radio stations, satellite stations, etc.) depicted on the display 244, arrow buttons for navigating through selectable commands and/or audio files depicted on the display 244, a thumb wheel for scrolling through items on the display 244, an alphanumeric keypad, etc. The user may utilize the display 244 and the user input mechanism 246 in a known manner to find and select audio files stored by (or other types of audio information processed by) the portable audio source 108. The portable audio source 108 may further include a data port or electrical interface 148 configured for interfacing with an external device such as a computer for purposes such as downloading audio files or software updates from the computer, uploading audio files to the computer, transmitting other types of data and user commands, charging an internal battery, etc.

Also in the example of FIG. 2, the portable audio enhancement device 112 is shown as including user input controls 258, output indicators 260 (and/or a display), and a power adapter 262. The portable audio enhancement device 112 may also include a microphone input 264 for connection with an associated microphone 166 for further audio quality enhancement as described above. In this example, the power adapter 262 is a standard barrel-type adapter configured to be plugged into an auxiliary power outlet (not shown) of a vehicle that is often located on the center console of the vehicle. Alternatively, the power adapter 262 may be an AC adapter configured to be plugged in an outlet of a building (e.g., a 120-V residential service line). As another alternative, the portable audio enhancement device 112 may include a replaceable or rechargeable battery and thus not require the power adapter 262.

FIG. 2 also shows another example of an implementation in which the portable audio enhancement device 112 is configured for accommodating the addition of one or more auxiliary or additional loudspeakers to the existing arrangement of the audio playback device 104 and related system. An auxiliary or additional loudspeaker may be one that is added to the existing system for the purpose of adding or accentuating a frequency response (e.g., an additional tweeter, midrange speaker, woofer or subwoofer, etc.) or for adding a channel, dimension or stage to the acoustic output (e.g., a center channel, a rear channel, a surround-sound channel, etc.), or for playing back only cellular telephone voice and data signals, or for sharing the output of the portable audio enhancement device 112 with an another playback device in addition to the illustrated audio playback device 104 and portable audio source 108 (e.g., a boom box, portable radio or CD player, additional stereo system, etc.). In some examples, the additional or auxiliary loudspeaker is one that is self-powered and hence does not depend on the illustrated audio playback device for its operation and does not need to be connected to the audio playback device 104. In all such cases, the portable audio enhancement device 112 may include a signal divider network that routes all or at least a portion of the enhanced audio signals to the additional or auxiliary loudspeaker. As an example, a “portion” of the enhanced audio signals may be signals of low frequency transmitted to a subwoofer added to the system; the signal divider network in this case may be a high and low pass filter network. As another example, the “portion” of the enhanced audio signals may be voice data transmitted to an additional loudspeaker dedicated for playback of telephony content, etc.

In the example shown in FIG. 2, the additional or auxiliary loudspeaker is a subwoofer 276 that has been added to the audio system 100. The subwoofer 276 may, for example, be an aftermarket product that is installed in the trunk or rear passenger area of a vehicle. To facilitate installation by a consumer, the subwoofer 276 may be a wireless device so as to avoid the need for accommodating a physical audio signal line and thus may include a suitable wireless receiver, e.g., an antenna 278 and associated radio frequency (RF) circuitry 280 as in the illustrated example. The portable audio enhancement device 112 may similarly include a suitable wireless transmitter, e.g., an antenna and associated RF circuitry, and also a suitable high and low pass filter network (not shown). By this configuration, low-frequency (subwoofer range) audio signals enhanced by the portable audio enhancement device 112 may be transmitted to the remotely situated subwoofer 276 via a wireless communication link 282 established between the wireless transmitter and the wireless receiver. By this configuration, additional loudspeakers such as the illustrative subwoofer 276 may be added to the audio system 100 without needing to modify or make connections to the in-built audio playback device 104, and such additional loudspeakers may be accounted for by the audio enhancement solution provided by the portable audio enhancement device 112.

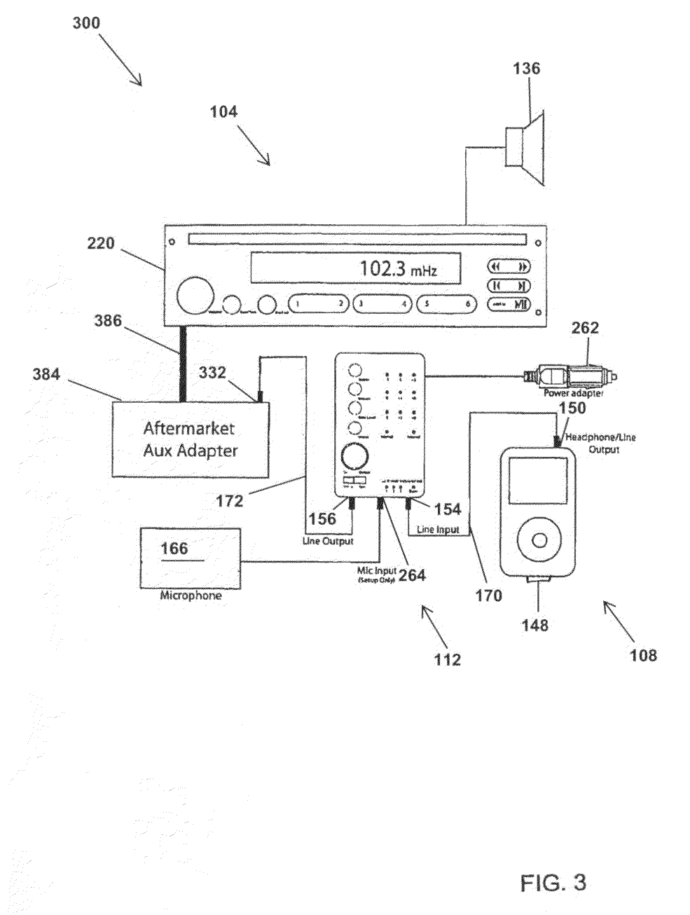

FIG. 3 is a block diagram of another example of an implementation of an audio system 300. Elements of the audio system 300 that are the same or similar to those of the audio systems described above and illustrated in FIGS. 1 and 2 are designated by the same reference numerals and their description will not be repeated here. In the example of FIG. 3, an audio input 332 to which the signal communication with the portable audio enhancement device 112 is made is not factory-provided as an auxiliary input jack or other component on the front panel 220. In this case, the audio input 332 is provided by an auxiliary adapter 384, which may be an aftermarket product purchased separately from and subsequently installed in the vehicle. The audio input adapter 384 may be placed in signal communication with the audio playback device 104 via an signal path 386 coupled to an appropriate connection point of the audio playback device 104, according to an installation procedure that may depend on the particular model of the audio playback device 104. The audio input adapter 384 may be located in any suitable position relative to the audio playback device 104 and the portable audio enhancement device 112. In a vehicle application, for example, the audio input adapter 384 may be mounted under the dashboard, in the glove compartment, etc.

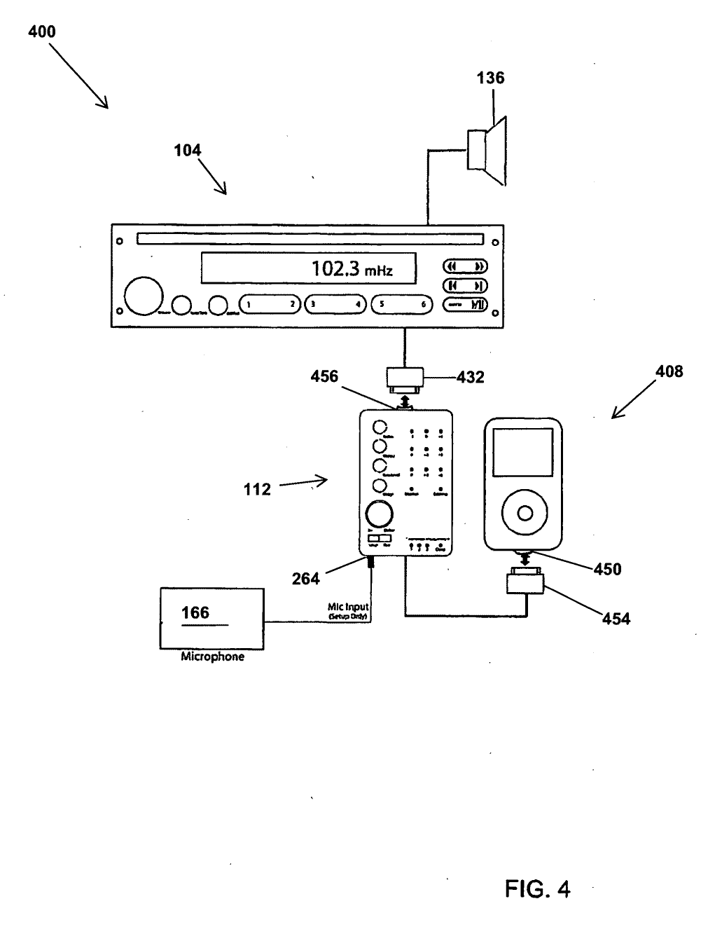

FIG. 4 is a block diagram of another example of an implementation of an audio system 400. Elements of the audio system 400 that are the same or similar to those of the audio systems described above and illustrated in FIGS. 1-3 are designated by the same reference numerals and their description will not be repeated here. In the example of FIG. 4, the portable audio enhancement device 112 is configured for use in conjunction with portable audio sources 408 that utilize a single interface 450 for transferring both data and an electrical current that may be utilized for powering external devices. The portable audio enhancement device 112 in this case includes a docking interface 454 configured for connecting to the complementary interface 450 of the portable audio source 408. Through this single connection, the portable audio enhancement device 112 receives audio signals from the portable audio source 408 and also draws power from the battery or battery recharging circuit of the portable audio source 408. This configuration eliminates the need for the power adapter 262 shown in FIGS. 2 and 3. One example of this type of portable audio source 408 is an IPod® media player or IPhone® multimedia device commercially available from Apple. As also illustrated in FIG. 4, the audio playback device 104 may be specifically configured for docking to this type of portable audio source 408 and thus may be originally equipped with a similar docking interface 432. In this case, the audio output of the portable audio enhancement device 112 may be configured as an interface 456 configured for compatibly connecting to the docking interface 432 of the audio playback device 104.

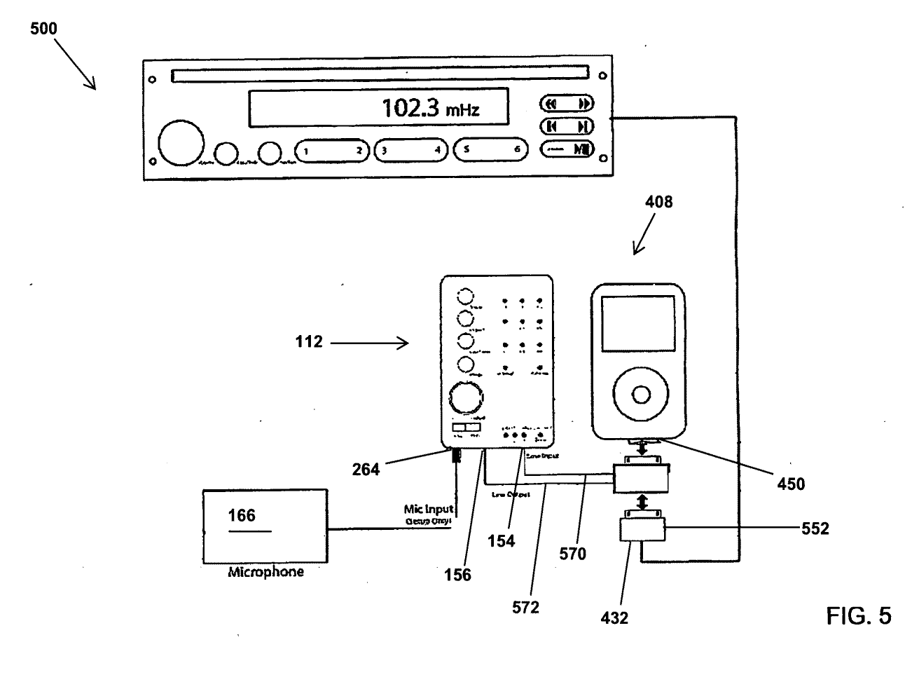

FIG. 5 is a block diagram of another example of an implementation of an audio system 500. Elements of the audio system 500 that are the same or similar to those of the audio systems described above and illustrated in FIGS. 1-4 are designated by the same reference numerals and their description will not be repeated here. In the example of FIG. 5, the portable audio enhancement device 112 is configured for use in conjunction with portable audio sources 408 that utilize a single interface 450 for transferring both data and an electrical current that may be utilized for powering external devices. The portable audio enhancement device 112 in this case includes a docking interface (or docking adapter) 552 configured for connecting to the complementary interface 450 of the portable audio source 408. Through this single connection, the portable audio enhancement device 112 receives audio signals from the portable audio source 408 and also draws power from the battery or battery recharging circuit of the portable audio source 408. As in the implementation illustrated in FIG. 4, this configuration eliminates the need for the power adapter 262 shown in FIGS. 2 and 3. Also similar to the implementation illustrated in FIG. 4, the audio playback device 104 may be specifically configured for docking to this type of portable audio source 408 and thus may be originally equipped with a similar docking interface 432. However, in the implementation illustrated in FIG. 5, the docking interface 552 is configured as an adapter that enables a portable audio enhancement device 112 having an audio input 154 and audio output 156 as shown in FIGS. 1-3 to be compatibly utilized in conjunction with a portable audio source 408 as shown in FIG. 4. For this purpose, in the present example the docking interface 552 may include a male connector adapted for docking to the female connector 450 of the portable audio source 408 and a female connector for docking to the male connector of the docking interface 432 provided with the audio playback device 104. The docking interface 552 may further include an audio output that may be placed in signal communication with the audio input 154 of the portable audio enhancement device 112 via a communication link 570, and an audio input that may be placed in signal communication with the audio output 156 of the portable audio enhancement device 112 via a communication link 572. By this configuration, audio signals flow from the portable audio source 408 to the portable audio enhancement device 112 via the docking interface 552 and the communication link 570, and enhanced audio signals flow from the portable audio enhancement device 112 to the audio playback device 104 via the communication link 572, the docking interface 552, the docking interface 432 of the audio playback device 104, and the signal path interconnecting the docking interface 432 and the audio playback device 104.

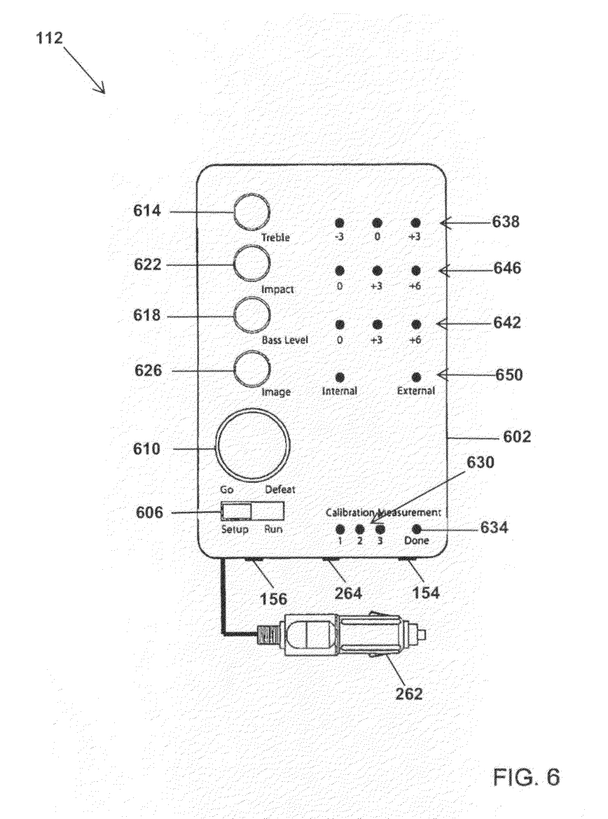

FIG. 6 is a front view of an example of an implementation of the portable audio enhancement device 112 that may be utilized in an audio system such as illustrated in FIGS. 1-5. The portable audio enhancement device 112 includes a housing 602 that may be sized to be handheld or pocket-sized. A line input 154, line output 156, microphone input 164, and power adapter 262 as described above are mounted at the housing. In other implementations in which the portable audio enhancement device 112 draws power from the portable audio source 408, the power adapter 262 is not provided and instead a dock connector 454 or other adapter (FIG. 4 or 5) configured to receive both audio signals (thus serving as the line input) and DC power current is provided. The portable audio enhancement device 112 may include various user input elements or controls. In the illustrated example, a mode switch 606 enables the user to toggle the mode of operation of the portable audio enhancement device 112 between a “set-up” mode (the measurement/analysis mode) and a “run” mode (the normal mode after a correction filter has been generated and is ready for implementation). The mode switch 606 is illustrated as being a sliding switch but a push button or any other type of two-position switch may be utilized. A defeat switch 610 may be provided (e.g., in the form of a push button) that enables the user to toggle the portable audio enhancement device 112 between an active or “go” state in which the correction filter is implemented, and an inactive or “defeat” state in which the correction filter is not implemented and the audio signals received from the portable audio source 108 are passed through the portable audio enhancement device 112 to the audio playback device 104 (FIG. 1) without undergoing the enhancement processing.

One or more controls may be provided to enable the user to adjust certain parameters of the enhanced audio signals so as to fine-tune those parameters according to the user's preferences. As an example, one or more frequency-adjusting controls may be provided. In the illustrated example, a treble level control 614 allows the user to make high-frequency adjustments to tailor the treble response, a bass level control 618 allows the user to make low-frequency adjustments to tailor the bass response, and an impact control 622 allows the user to change the character of the bass response by adding or accentuating some higher-frequency bass characteristics to the audio signals. Other frequency ranges (e.g., midrange, sub-base) may also be controlled in a like manner (not shown). In the illustrated example, these frequency-adjusting controls are implemented as three-position controls to allow the use of simple push-button controls. Alternatively, the frequency-adjusting controls may be configured to enable a greater number of incremental adjustments, i.e, finer tuning, in which case the controls may be provided in the form of rotatable knobs or the like. Additionally in the illustrated example, an “image” switch 626 is provided that enables the user to control whether phase correction is applied by the portable audio enhancement device 112. This feature is useful when the portable audio enhancement device 112 is operated in conjunction with an audio playback device 108 that includes matrix surround sound processing such as Dolby® PLII or Logic 7®. This type of sound processing analyzes the phase between left and right channels to determine the steering angle for the algorithm to steer sounds toward the rear. This type of sound processing may not be compatible with the phase correction implemented by the portable audio enhancement device 112, in which case the user may utilize the image switch 626 to defeat, or turn off, the phase correction function. Alternatively or additionally, other controls may be provided to enable adjustment of other parameters of the enhanced audio signals such as, for example, impulse response, dynamic range enhancement, reverb, etc.

The portable audio enhancement device 112 may further include various output indicators to provide information to the user. In the illustrated example, three red LEDs 630 marked “1,” “2” and “3” and a green LED 634 marked “Done” are located under the label “Calibration Measurement.” During the set-up routine, the red LEDs 630 indicate the progress of the analysis being performed and the green LED 634 indicates when the analysis has been completed, thus informing the user that the microphone 166 (FIG. 1) may be disconnected and the portable audio enhancement device 112 is ready for normal operation. Sets 638, 642, 646 of three LEDs are located next to the respective treble, bass level and impact controls 614, 618, 622 to indicate the positions to which these controls have been set. Two LEDs 650 marked “internal” and “external” are located next to the image control 626 to indicate whether phase correction is active or inactive. Alternatively, a display such as an LCD may be provided to display such information to the user. It will also be understood that various other user inputs and outputs may be provided as necessary for facilitating the operation of the portable audio enhancement device 112.

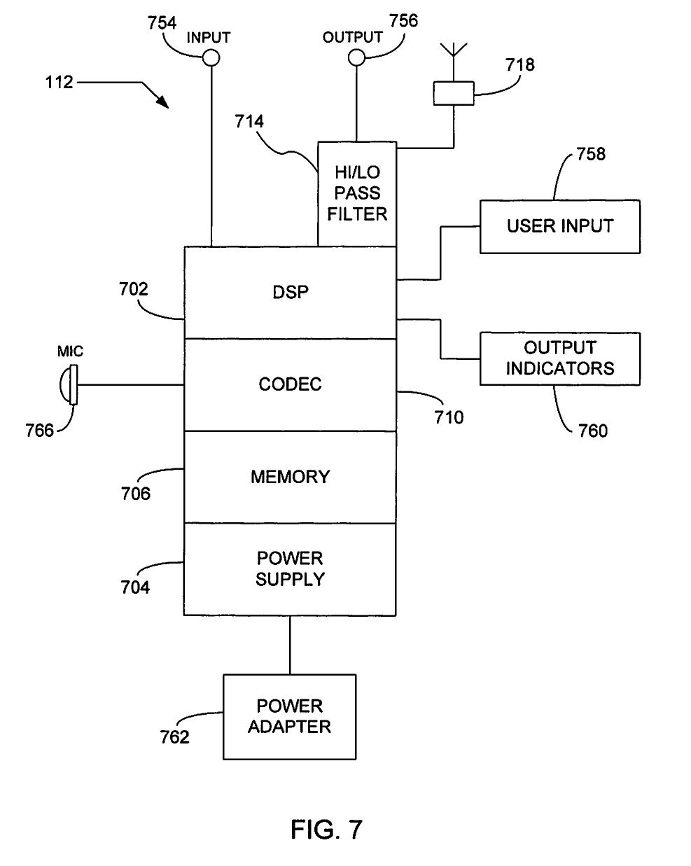

FIG. 7 is a block diagram of an example of an implementation of the portable audio enhancement device 112, in which functional blocks are intended to represent structures (e.g., circuitries, mechanisms, hardware, firmware, software stored in memory, etc.) that may be provided by the portable audio enhancement device 112. It will be understood that the various functional blocks and electrical signal lines have been arbitrarily located for purposes of illustration and simplicity, and hence their relative positions as illustrated in FIG. 7 are not limiting in any manner. Persons skilled in the art will appreciate that, in practice, the functions of the portable audio enhancement device 112 may be implemented in a wide variety of ways and not necessarily in the exact manner illustrated in FIG. 7 and described below.

The portable audio enhancement device 112 may generally include an electronic controller 702, a power supply 704, one or more memories 706, a user input mechanism 758, output indicators or a display 760, an audio signal input 754, an audio signal output 756, and a microphone 766. The electronic controller 702 of the portable audio enhancement device 112 may be any microprocessor-based circuitry configured for controlling and coordinating the various functions provided by the portable audio enhancement device 112, and may be primarily embodied in a digital signal processing (DSP) unit, application specific integrated circuit (ASIC), other application-specific circuitry, or other type of microprocessor. At least one memory unit 706 is provided for storing data, software instructions or algorithms utilized by the electronic controller 702 for the measurement and analysis of acoustic environment as described above, and for storing the correction filter generated as described above. The user input mechanism 756 may include any controls manipulated by the user, examples of which are described above in conjunction with FIG. 6. The output indicators 760 may include a display, light-emitting diodes (LEDs), or other types of output element serving to provide information to the user, examples of which are described above in conjunction with FIG. 6. The power supply 704 represents a power regulating circuit and may interface with a power adapter 762 configured to in turn interface with a suitable power supply as described above in conjunction with FIG. 2. Alternatively, the portable audio enhancement device 112 may be adapted for drawing power from the battery or battery recharging circuit of the portable audio source 408 (FIG. 4 or 5), in which case the audio input 754 of the portable audio enhancement device 112 is also utilized to receive such power as described above in conjunction with FIG. 4 or 5. As a further alternative, the power supply 704 may include an internal battery.

The portable audio enhancement device 112 is also shown as including a coder-decoder (CODEC) 710 controlled by the DSP for performing encoding, decoding, analog-to-digital (A/D) conversion and digital-to-analog (D/A) conversion of signals as needed. Generally, the CODEC 710 may be a device or software (either external or part of the electronic controller 702) capable of encoding and/or decoding a digital data stream or signal. For example, the CODEC 710 may convert analog audio signals received from the audio input 754 into digital signals for enhancement processing by the DSP 702, and may convert the digital enhanced audio signals outputted by the DSP 702 into analog audio signals for output at the audio output 756. During the set-up routine described above, the CODEC 710 may convert analog audio signals sampled by the microphone 766 into digital signals for analysis by the DSP 702 in the course of generating the correction filter according to which audio signals are to be processed in preparation for transmission to the audio playback device 104 (FIG. 1). In some implementations as described above, the portable audio enhancement device 112 may further include a high and low pass filter network 714 so that enhanced audio signals of a selected frequency range (e.g., low-frequency signals) may be routed to a wireless transmitter 718 for transmission to an auxiliary loudspeaker (e.g., a subwoofer). As appreciated by persons skilled in the art, the portable audio enhancement device 112 may include many other audio enhancement-related functions and structures not specifically described or illustrated here.

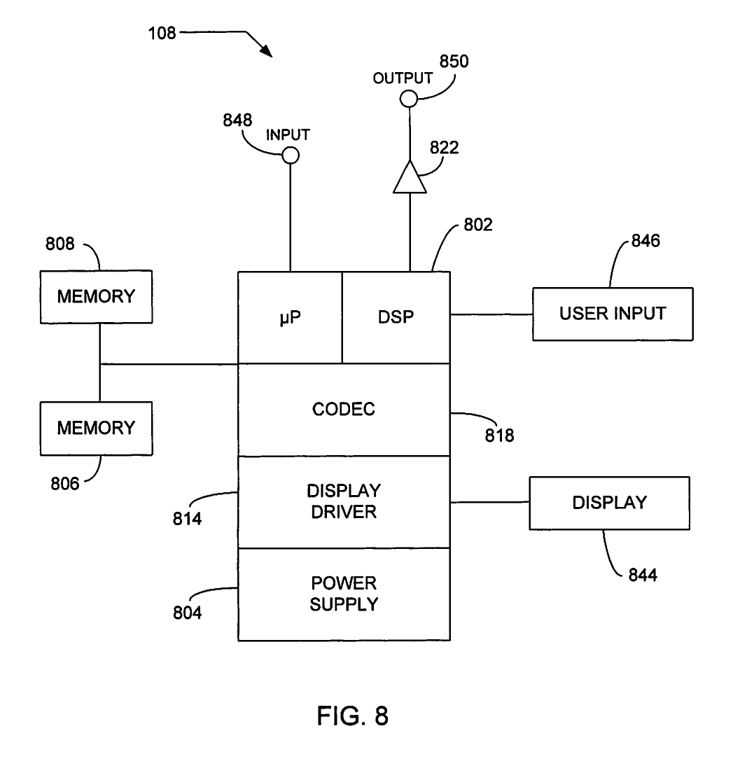

FIG. 8 is a block diagram of an example of an implementation of the portable audio source 108, in which functional blocks are intended to represent structures that may be provided by the portable audio source 108. It will be understood that the various functional blocks and electrical signal lines have been arbitrarily located for purposes of illustration and simplicity, and hence their relative positions as illustrated in FIG. 8 are not limiting in any manner. Persons skilled in the art will appreciate that, in practice, the functions of the portable audio source 108 may be implemented in a wide variety of ways and not necessarily in the exact manner illustrated in FIG. 8 and described below.

The portable audio device 108 may generally include an electronic controller 802, a power supply 804, one or more memories 806, 808, a user input mechanism 846, a display 844, a signal input 848, and an audio signal output 850. The electronic controller 802 may be any microprocessor-based circuitry configured for controlling and coordinating the various functions provided by the portable audio device 108, reading data and controlling data/signal flow. In particular, the electronic controller 802 includes audio signal processing circuitry for generating audio signals for playback based on user-selected audio files. The electronic controller 802 may, for example, represent a central processing unit (CPU), system random-access memory (RAM), system read-only memory (ROM), one or more analog-to-digital (A/D) converters, and one or more digital-to-analog (D/A) converters as needed for performing its various functions. The power supply 804 represents a power regulating circuit and may also represent the power source (e.g., an internal replaceable or rechargeable battery) that interfaces with the power regulating circuit. At least one memory unit 806 is provided for storage of audio files and thus should be a non-volatile memory unit such as, for example, a flash memory, a micro-drive, etc. The memory unit 806 holding audio files may be an internal memory or an external memory (i.e., a removable memory unit). Another memory unit 808 may be provided for storing other types of data files, software applications utilized by the portable audio source 108, etc. The display 844 is utilized to display file names associated with audio files stored in memory 806 as well as other information, and cooperates with the user input mechanism 846 to enable the user to select audio files and perform other interactions with the portable audio device 108. The display 844 is typically a liquid crystal display (LCD) although more generally may be any type of display suitable for the portable audio source 108.

Many controlling functions of the portable audio source 108 may be handled by specific circuitry such as may be embodied in a DSP, and thus the electronic controller 802 is schematically depicted as including a main processor and a DSP. For example, the DSP may handle the scanning of the user input mechanism 846 for user-inputted events (e.g., keystrokes, wheel scrolling, button entries, etc.). As another example, a display driver 814 may be provided for managing the interface with and operations of the display 844. The portable audio source 108 is also shown as including a CODEC 818 controlled by the main processor and/or DSP, which may generally represent an encoder and decoder and any associated A/D and D/A converters. For example, the CODEC 818 may be utilized for compression and decompression of audio files. When a user selects an audio file for playback, the CODEC 818 may convert the digital data contained in the selected audio file into analog audio signals which are then transmitted to the audio output 850 for transmission to the portable audio enhancement device 112 (FIG. 1). The CODEC 818 may also be responsible for compressing audio files in preparation for storage in the memory unit 806. The portable audio source 108 may also include one or more amplifiers 822 for amplifying the outgoing audio signals. As appreciated by persons skilled in the art, the portable audio source 108 may include many other functions and structures not described or illustrated here, such as wireless circuitry, camera circuitry, cellular telephony circuitry, GPS circuitry, database management and word processing functions, etc.

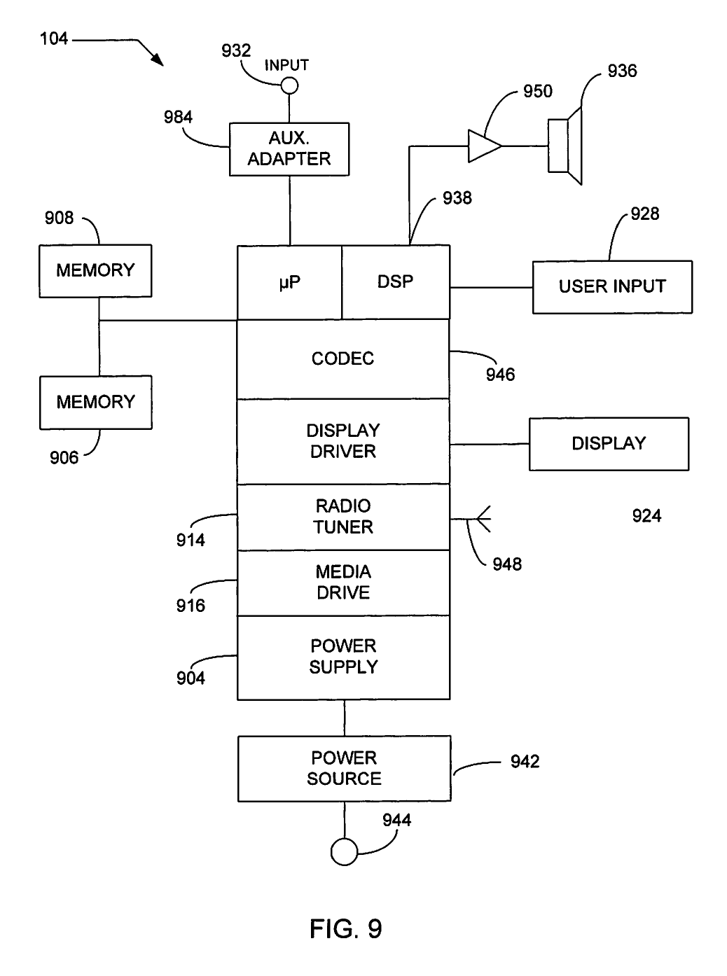

FIG. 9 is a block diagram of an example of an implementation of the audio playback device 104, in which functional blocks are intended to represent structures that may be provided by the audio playback device 104. It will be understood that the various functional blocks and electrical signal lines have been arbitrarily located for purposes of illustration and simplicity, and hence their relative positions as illustrated in FIG. 9 are not limiting in any manner. Persons skilled in the art will appreciate that, in practice, the functions of the audio playback device 104 may be implemented in a wide variety of ways and not necessarily in the exact manner illustrated in FIG. 9 and described below.

The audio playback device 104 typically includes an electronic controller 902, a power supply 904, one or more memories 906, 908, a user input mechanism 928, a display 924, a radio and/or satellite tuner 914, one or more media drives 916, an audio signal input 932, and an audio signal output 938. The electronic controller 902 may be any microprocessor-based circuitry configured for controlling and coordinating the various functions provided by the audio playback device 104, reading data and controlling data/signal flow, and thus may include a main processor and a DSP dedicated for audio signal processing and control operations. The audio playback device 104 may also include one or more memory units 906, 908 as needed for storing data and software instructions. The display 924 may be utilized to display various types of information to the user, such as file names associated with audio files being played by the audio playback device 104 associated either with the use of the portable audio source 108 or the media drive 916 and, specifically in a vehicle application, information relating to the operation of the radio tuner 914, navigation information, information regarding non-audio related operations of the vehicle, etc. The user input mechanism 928 may include various buttons, knobs and the like for pushing or rotating by the user for various purposes such as switching between and interfacing with various available audio sources (e.g., the portable audio source 108, media drive 916, radio 914), selecting audio files, music tracks or radio stations, etc. The power supply 904 of the audio playback device 104 represents a power regulating circuit that receives power from a suitable power source 942. In the case of a home stereo, the power source 942 may represent an outlet of an AC power line source. In the case of a vehicle stereo, the power source 942 is typically the vehicle's 12-V battery. The vehicle's battery may further communicate with an auxiliary power outlet 944 provided in the vehicle and adapted for interfacing with a device such as the portable audio source 108 or the portable audio enhancement device 112 (FIG. 1).

The audio playback device 104 is also generally shown as including a CODEC 946 for providing encoding, decoding, A/D and/or D/A conversion of audio signals, RF signals, etc. as necessary. The radio tuner 914 represents circuitry configured for processing RF signals received from an antenna 948. The media drive 916 represents one or more drives configured for driving various removable media such as CDs, DVDs, cassette tapes, etc. The audio input 932 is configured for connection to a communication link established with the audio output of a portable device such as the portable audio source 108 or the portable audio enhancement device 112. In some implementations, the communication link is a physical line (e.g., wire) in which case the audio input 932 is a line jack of standard size and often referred to as an auxiliary input. As described above, the audio input 932 may be originally provided by the manufacturer of the audio playback device 104 or vehicle, and thus may be located on a front face of the audio playback device 104 or otherwise integrated with the audio playback device 104, or may be provided at a location more remote from the audio playback device 104 such as the center console of the vehicle, etc. In other implementations, the audio input 932 may be provided as part of an aftermarket adapter 984 configured to be wired to the audio playback device 104. The audio output 938 is in signal communication with the loudspeakers 936 of the audio playback device 104. One or more amplifiers 950 are provided to boost the gain of the outputted audio signals and the gain may be controlled by the user via the user input mechanism 928. As appreciated by persons skilled in the art, the audio playback device 104 may include many other functions and structures not described or illustrated here, such as cellular telephony circuitry, GPS circuitry, etc.

It will be understood that the term “audio file” is not limited to audio-only applications but more generally encompasses various types of media files that may provide other types of media content in addition to audio content. As an example, an audio file may include both audio and video content in MPEG or any other suitable format. Portable audio sources and audio playback devices may be capable of playing audio/video content such as movies, for example.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A portable audio enhancement device for use with a portable audio source and audio playback device, where both the portable audio source and audio playback device are located separately from the portable audio enhancement device, the portable audio enhancement device comprising:
an audio input;
an audio output; and
an audio signal processor in signal communication with both the audio input and the audio output, wherein the audio input is configured to receive audio signals produced by the portable audio source, wherein the audio signal processor is configured to produce enhanced audio signals from the received audio signals, and where the audio output is configured to output the enhanced audio signals to the audio playback device.

2. The portable audio enhancement device of claim 1, further including a signal dividing network communicating with the audio signal processor and configured to output at least a portion of the enhanced audio signals to a loudspeaker powered independently of the audio playback device.

3. The portable audio enhancement device of claim 1, where the audio signal processor is configured to perform an enhancement selected from the group consisting of frequency response enhancement, phase response enhancement, impulse response enhancement, dynamic range enhancement, and combinations of two or more of the foregoing.

4. The portable audio enhancement device of claim 1, where the portable audio enhancement device further includes a microphone for converting sound into sample audio signals, and the audio signal processor is configured to perform an analysis of the sample audio signals and perform an enhancement based on the analysis.

5. The portable audio enhancement device of claim 4, where the enhancement is selected from the group consisting of frequency response enhancement, phase response enhancement, impulse response enhancement, dynamic range enhancement, and combinations of two or more of the foregoing.

6. The portable audio enhancement device of claim 4, where the audio signal processor is configured to generate a correction filter based on the analysis and applying the correction filter to the audio signals received by the audio input to produce the enhanced audio signals.

7. The portable audio enhancement device of claim 6 further including a memory, where the audio signal processor is configured to store the correction filter in the memory.

8. The portable audio enhancement device of claim 1, where the portable audio enhancement device further includes a user-operated control configured to enable adjustment of a parameter of the enhanced audio signals.

9. The portable audio enhancement device of claim 8, where the parameter is selected from the group consisting of frequency response, phase response, impulse response, and dynamic range enhancement.

10. The portable audio enhancement device of claim 1, where at least one of the audio input and the audio output is configured to connect to the portable audio source or the audio playback device via an physical signal path.

11. The portable audio enhancement device of claim 1, where at least one of the audio input and the audio output is configured to wirelessly communicating with the portable audio source or the audio playback device.

12. An audio system comprising:
a portable audio source;
a portable audio enhancement device located separately from the portable audio source, wherein the portable audio enhancement device is in signal communication with the portable audio source via a first signal path and wherein the portable audio enhancement device includes an audio signal processor; and
an audio playback device located separately from the portable audio source and the portable audio enhancement device,
wherein the audio playback device is in signal communication with the portable audio enhancement device via a second signal path,
wherein the portable audio source is configured to produce audio signals,
wherein the portable audio enhancement device is configured to receive the audio signals and in response produce enhanced audio signals,
wherein the audio playback device is configured to receive the enhanced audio signals and in response produce signals for playback that are transmitted to one or more loudspeakers in signal communication with the audio playback device.

13. The audio system of claim 12, further including an additional loudspeaker, where the portable audio enhancement device further includes a signal dividing network and is configured to transmit enhanced audio signals processed by the signal-dividing network from the portable audio enhancement device to the additional loudspeaker.

14. The audio system of claim 13, where the additional loudspeaker includes a wireless receiver, and the portable audio enhancement device further includes a wireless transmitter configured to transmit the low-frequency, enhanced audio signals to the wireless receiver of the additional loudspeaker via a wireless communication link.

15. The audio system of claim 12, where the portable audio source further includes a user input component configured to enable a user to select audio information for output, and the circuitry of the portable audio source is configured to produce audio signals corresponding to the selected audio information.

16. The audio system of claim 15, where the audio information is selected from the group consisting of an audio file stored in a memory, an audio file stored on removable media, and a wireless broadcast.

17. The audio system of claim 12, where the portable audio source further includes a memory configured to store audio files, a display configured to display information indicative of audio files stored in the memory, and a user input component configured to enable a user to select a stored audio file, and the circuitry of the portable audio source is configured to produce audio signals corresponding to the selected audio file.

18. The audio system of claim 12, where the portable audio source further includes a media drive configured to read audio files stored on removable media, a display configured to display information indicative of audio files stored on the removable media, and a user input component configured to enable a user to select a stored audio file, and the circuitry of the portable audio source is configured to produce audio signals corresponding to the selected audio file.

19. The audio system of claim 12, where the portable audio source further includes a receiver configured to receive broadcasted audio information over a plurality of wireless channels, and a user input component configured to enable a user to select a wireless channel over which to receive selected audio information, and the circuitry of the portable audio source is configured to produce audio signals corresponding to the selected audio information.

20. The audio system of claim 12, where the portable audio enhancement device is configured to perform an enhancement selected from the group consisting of frequency response enhancement, phase response enhancement, impulse response enhancement, dynamic range enhancement, and combinations of two or more of the foregoing.

21. The audio system of claim 12, where the portable audio enhancement device further includes a user-operated control configured to initiate the enhancement.

22. The audio system of claim 12, where the portable audio enhancement device further includes a microphone for receiving the sound outputted from the loudspeaker and converting the received sound into sample audio signals, and the audio signal processor is configured to perform an analysis of the sample audio signals and performing an enhancement based on the analysis.

23. The audio system of claim 22, where the enhancement is selected from the group consisting of frequency response enhancement, phase response enhancement, impulse response enhancement, dynamic range enhancement, and combinations of two or more of the foregoing.

24. The audio system of claim 22, where the portable audio enhancement device further includes a user-operated set-up control configured for initiating the analysis of the sample audio signals.

25. The audio system of claim 12, where the portable audio enhancement device further includes a user-operated control configured to enable adjustment of a parameter of the enhanced audio signals.

26. The audio system of claim 25, where the parameter is selected from the group consisting of frequency response, phase response, impulse response, and dynamic range enhancement.

27. The audio system of claim 12, where portable audio enhancement device further includes an internal power source.

28. The audio system of claim 12, where the portable audio enhancement device further includes a power adapter configured to couple to a power source external to the portable audio enhancement device.

29. The audio system of claim 12, where the first audio input of the portable audio enhancement device is further configured to receive power from the portable audio source.

30. The audio system of claim 12, further including an audio input adapter positioned remotely from the audio playback device and communicating the audio playback device via an auxiliary line, where the audio input adapter includes the second audio input with which the portable audio enhancement device communicates.

31. The audio system of claim 12, where the audio playback device is mounted in a vehicle.

32. The audio system of claim 12, where at least one of the two signal paths is a wired connection.

33. The audio system of claim 12, where at least one of the two signal paths is a wireless link.

34. A method for enhancing sound outputted by an audio playback device, the method comprising:
placing a portable audio enhancement device in signal communication with an audio output of a portable audio source and with an audio input of an audio playback device;
transmitting audio signals from the portable audio source to the portable audio enhancement device;
operating the portable audio enhancement device to perform an enhancement on the audio signals to produce enhanced audio signals;
transmitting the enhanced audio signals to the audio playback device; and
outputting the audio signals as sound from one or more loudspeakers communicating with the audio playback device.

35. The method of claim 34, further including transmitting at least a portion of the enhanced audio signals from the portable audio enhancement device to an additional loudspeaker.

36. The method of claim 35, where transmitting to the additional loudspeaker is done wirelessly.

37. The method of claim 34, where the audio signals selected from the portable audio source are selected from the group consisting of audio signals corresponding to an audio file stored in a memory, audio signals corresponding to an audio file stored on removable media, and audio signals corresponding to a wireless broadcast.

38. The method of claim 34, where operating the portable audio enhancement device includes converting sound outputted from the loudspeaker into sample audio signals, analyzing the audio signals, and generating a correction filter based on the analysis, and where performing the enhancement includes applying the correction filter to the audio signals received from the portable audio source to produce the enhanced audio signals.

39. The method of claim 38, where operating the portable audio enhancement device further includes operating a microphone of the portable audio enhancement device to pick up the sound and convert the sound into the sample audio signals and, after the analysis, disconnecting the microphone.

40. The method of claim 38, where operating the portable audio enhancement device further includes connecting a microphone to the portable audio enhancement device to pick up the sound and convert the sound into the sample audio signals and, after the analysis, disconnecting the microphone.

41. The method of claim 34, where the enhancement is selected from the group consisting of phase correction, frequency response correction, impulse response correction, dynamic range enhancement, and combinations of two or more of the foregoing.

42. The method of claim 41, further including switching the portable audio enhancement device between a first state in which the enhancement is performed and a second state in which the enhancement is not performed.

43. The method of claim 34, further including connecting the portable audio enhancement device to a remotely situated power source.

44. The method of claim 43, where the portable audio enhancement device is connected to a power outlet of a vehicle and the power source is a battery of the vehicle.

45. The method of claim 43, where the power source is located in the portable audio source.

46. The method of claim 34, where the audio playback device is mounted in a vehicle.

47. The method of claim 34, where placing the portable audio enhancement device in signal communication with the audio output of the portable audio source or the audio input of the audio playback device is done by either an electrical conduit or wirelessly.

48. A method for enhancing sound emitted from a plurality of loudspeakers in signal communication with an audio playback device with a portable audio enhancement device, the method comprising:
receiving audio signals produced from a portable audio source;
enhancing the audio signals with the portable audio enhancement device to produce enhanced audio signals; and
transmitting the enhanced audio signals to an audio playback device which produces the enhanced sound emitted from the plurality of loudspeakers in response to receiving the enhanced audio signals.

49. The method of claim 48, wherein enhancing includes converting sound emitted from the plurality of loudspeakers into sample audio signals, analyzing the sample audio signals, and generating a correction filter based on the analysis, and wherein performing the enhancement includes applying the correction filter to the audio signals received from the portable audio source to produce the enhanced audio signals.

50. The method of claim 49, wherein enhancing further includes operating a microphone of the portable audio enhancement device to pick up the sound and convert the emitted sound into the sample audio signals and, after the analysis, disconnecting the microphone.

51. The method of claim 50, where enhancing further includes connecting a microphone to the portable audio enhancement device to pick up the emitted sound and convert the emitted sound into the sample audio signals and, after the analysis, disconnecting the microphone.
